(19) United States
(12) Patent Application Publication
(10) Pub. No.: US 2002/0013646 A1
(43) Pub. Date: Jan. 31, 2002

(54) Motor vehicle steering system

(76) Inventors: Katsutoshi Nishizaki, Nabari-shi (JP); Shiro Nakano, Osaka (JP); Masaya Segawa, Tenri-shi (JP); Ryouhei Hayama, Nabari-shi (JP)

Correspondence Address: RABIN & CHAMPAGNE, PC, 1101 14TH STREET, NW, SUITE 500, WASHINGTON, DC, 20005, US

(21) Appl. No.: 09/862,697

(22) Filed: May 23, 2001

(30) Foreign Application Priority Data
May 29, 2000 (JP) 2000-158589

(51) Int. Cl. B62D 6/00

(52) U.S. Cl. 701/41; 180/443

(57) ABSTRACT

A motor vehicle steering system for controlling driving of a steering mechanism of a motor vehicle is provided. The system includes: a brake actuation detecting circuit for detecting actuation of a braking mechanism of the motor vehicle; a speed comparing circuit for judging which of left and right wheels of the motor vehicle has a higher wheel speed; a speed judging circuit for judging whether or not a speed difference between the left and right wheels of the motor vehicle exceeds a predetermined threshold value; and a steering control circuit for controlling the steering mechanism. In response to the detection of the actuation of the braking mechanism, the steering control circuit additionally turns the steerable wheels of the motor vehicle by a control steering angle toward one of the left and right wheels having a lower wheel speed on the basis of a result of the judgment by the speed comparing circuit on condition that the speed difference between the left and right wheels exceeds the predetermined threshold value.

### BACKGROUND OF THE INVENTION

1. Field of the Invention

The present invention relates to a motor vehicle steering system which is capable of controlling the attitude of a motor vehicle by controlling a steering mechanism.

2. Description of Related Art

A steering system for a motor vehicle has been proposed, which has no mechanical connection between a steering wheel and a steering mechanism for steering steerable vehicle wheels (see, for example, Japanese Unexamined Patent Publication No. 9-142330 (1997)). In the motor vehicle steering system, the direction and degree of operation of the steering wheel are detected, and a driving force from an actuator such as an electric motor is applied to the steering mechanism on the basis of the result of the detection.

This arrangement obviates the need for mechanical coupling between the steering mechanism and the steering wheel. Therefore, upward thrust of the steering wheel can be prevented at collision of the motor vehicle. Further, this arrangement allows for structural simplification and weight reduction of the steering mechanism, and more flexible placement of the steering wheel. Moreover, this arrangement makes it possible to employ other operation means such as a steering lever and a steering pedal instead of the steering wheel.

In the motor vehicle steering system having the aforesaid construction, a relationship between the operation of the steering wheel and the operation of the steering mechanism can flexibly be modified through an electrical control. Therefore, the maneuverability of the motor vehicle is expected to be drastically improved.

For example, a target yaw rate or a target lateral acceleration is determined in accordance with an operation torque or an operation angle of the steering wheel, and the operation of the steering mechanism is controlled on the basis of the target yaw rate or the target lateral acceleration for attitude control of the motor vehicle. Thus, the dynamic characteristics of the motor vehicle can be optimized for the steering operation.

Where the attitude control of the motor vehicle is carried out by the aforesaid steer-by-wire system, an actual yaw rate of the motor vehicle is detected and a target yaw rate is determined in accordance with the operation of the steering wheel. The steering angle of the steering mechanism is determined so as to bring the actual yaw rate closer to the target yaw rate. More specifically, a target steering angle is determined on the basis of a deviation of the actual yaw rate from the target yaw rate, and the steering mechanism is controlled so as to equalize an actual steering angle of the steering mechanism with the target steering angle.

Where the steering actuator is constantly controlled on the basis of the deviation of the actual yaw rate from the target yaw rate, however, over control may result. Therefore, the motor vehicle is yawed even during ordinary straight traveling, particularly during low speed traveling.

A conceivable approach to this problem is to preset a certain threshold condition to control the steering actuator less sensitively. For example, the attitude control through the control of the steering actuator is not performed until the deviation of the actual yaw rate from the target yaw rate reaches a predetermined threshold.

With this arrangement, however, the control is delayed, failing to effectively suppress attitude instability of the motor vehicle on a so-called μ-split road. The term “μ-split road” herein means a road having significantly different friction coefficients with respect to left and right wheels of the motor vehicle. A typical case is such that the right wheels are on a dry asphalt road surface and the left wheels are on an iced road surface.

When a braking mechanism of the motor vehicle is actuated on such a μ-split road, a greater braking force is generated on a higher μ (friction coefficient) side, so that a greater yaw moment abruptly acts on the motor vehicle to make the attitude of the motor vehicle unstable. Therefore, a so-called counter-steering control operation is preferably performed to apply a control yaw moment in an opposite direction to the motor vehicle for stabilization of the attitude of the motor vehicle.

However, the aforesaid arrangement which entails the delay in the control cannot suppress the yaw moment occurring at the initial stage of the braking operation, so that the motor vehicle inevitably suffers from significant attitude instability.

The delay in the control may otherwise be caused by a delay due to the calculation of the target yaw rate, a delay attributable to the responsiveness of the steering actuator and the like, and is totally about 120 msec to 130 msec. The delay in the control is not negligible when the braking operation is performed on the μ-split road.

### SUMMARY OF THE INVENTION

It is an object of the present invention to provide a motor vehicle steering system which is capable of stabilizing the attitude of a motor vehicle during a braking operation.

The present invention is directed to a motor vehicle steering system for controlling driving of a steering mechanism (2, 3) of a motor vehicle. The system comprises: a brake actuation detecting circuit (60, 50, Sl) for detecting actuation of a braking mechanism (53, 54) of the motor vehicle; a speed comparing circuit (60, 50, S3) for judging which of left and right wheels of the motor vehicle has a higher wheel speed; a speed judging circuit (60, 50, S2) for judging whether a speed difference between the left and right wheels of the motor vehicle exceeds a predetermined threshold value; and a steering control circuit (20, S4, S5) for controlling the steering mechanism. In response to the detection of the actuation of the braking mechanism by the brake actuation detecting circuit, the steering control circuit controls the steering mechanism on the basis of a result of the judgment by the speed comparing circuit so as to additionally turn the steerable wheels of the motor vehicle by a control steering angle toward one of the steerable wheels having a lower wheel speed on condition that the speed judging circuit judges that the speed difference between the left and right wheels exceeds the predetermined threshold value. Parenthesized alphanumeric characters denote corresponding components to be described later in the embodiment of the invention, but do not intend to limit the invention to the embodiment. This definition is effectual in this section.

In accordance with the present invention, it is judged whether the difference in wheel speed (speed difference) between the left and right wheels exceeds the predetermined threshold value when the braking mechanism is actuated to apply a braking force to the motor vehicle. If the speed difference between the left and right wheels is greater at the braking, there is a high possibility that the motor vehicle is traveling on a road having significantly different friction coefficients with respect to the left and right wheels of the motor vehicle. In such a case, the steering mechanism is controlled so as to additionally turn the steerable wheels of the motor vehicle by the control steering angle toward the lower-speed wheel. Thus, a control yaw moment is applied to the motor vehicle to counter-balance a yaw moment acting on the motor vehicle due to the different friction coefficients of the road with respect to the left and right wheels of the motor vehicle.

In the present invention, the steering mechanism is promptly controlled on the basis of the judgment of whether or not the speed difference between the left and right wheels exceeds the threshold value at the actuation of the braking mechanism. When the braking operation is performed during traveling on a so-called μ-split road, the attitude control of the motor vehicle can be effected with a satisfactory responsiveness to counter-balance the yaw moment acting on the motor vehicle due to the braking operation.

In accordance with one embodiment of the present invention, the steering control circuit controls the steering mechanism so as to additionally turn the steerable wheels of the motor vehicle by the control steering angle toward the lower-speed wheel on condition that the speed difference exceeds the threshold value after a lapse of a predetermined period.

With this arrangement, whether or not the steerable wheels are to be additionally turned by the control steering angle is judged on the basis of the speed difference detected after the lapse of the predetermined period from the detection of the actuation of the braking mechanism. Thus, the overcontrol can be prevented, whereby an ordinary braking operation is prevented from being improperly performed.

The predetermined period is preferably a very short period on the order of 40 msec to 70 msec for prevention of significant attitude instability of the motor vehicle. More specifically, where the steering control circuit repeatedly performs the steering mechanism controlling operation in a certain control cycle (10 msec), the predetermined period may be four to five times the control cycle.

The control steering angle, which is to be added to the steering angle of the steering mechanism when the speed difference between the left and rightwheels exceeds the threshold value, may have a constant value. Thus, the control operation to be performed by the steering control circuit is simplified. Accordingly, the steering mechanism can promptly be controlled, so that the yaw moment occurring at the initial stage of the braking of the motor vehicle can effectively be suppressed.

The steering control circuit may variably set the control steering angle depending on a difference in braking condition between the left and right wheels.

With this arrangement, the control yaw moment can properly be applied to the motor vehicle through the control of the steering mechanism in accordance with the difference between the friction coefficients of the road with respect to the left and right wheels. Thus, the attitude control can more advantageously be performed during the braking operation.

The inventive motor vehicle steering system may cooperate with a braking control circuit (60) for controlling the braking mechanism. In this case, the braking control circuit may be adapted to detect the actuation of the braking mechanism and the speeds of the left and right wheels of the motor vehicle. The braking control circuit may further be adapted to compare the speeds of the left and right wheels with each other and to compare the speed difference between the left and right wheels with the threshold value.

In this case, the steering control circuit and the braking control circuit may be connected to each other via a proper communication line (50). That is, the steering control circuit acquires data from the braking control circuit via the communication line, the data including data indicative of whether or not the braking mechanism is actuated, data indicative of which of the left and right wheels has a higher wheel speed, and data indicative of whether or not the speed difference between the left and right wheels exceeds the threshold value.

The steering mechanism preferably has no mechanical connection to a steering operation member (1) such as a steering wheel, or is adapted to be brought out of mechanical engagement with the steering operation member as required. With this arrangement, the steering mechanism can electrically be controlled in accordance with the operation of the steering operation member, whereby a steering control operation can be performed as intended by a driver and the behavior of the motor vehicle can easily be stabilized through the steering control independent of the operation of the steering operation member.

The foregoing and other objects, features and effects of the present invention will become more apparent from the following description of the preferred embodiments with reference to the attached drawings.

### BRIEF DESCRIPTION OF THE DRAWINGS

FIG. 1 is a conceptual diagram for explaining the basic construction of a motor vehicle steering system according to one embodiment of the present invention;

FIG. 2 is a schematic diagram for explaining how a braking operation is performed on a so-called μ-split road;

FIG. 3 is a flow chart for explaining the operation of a steering controller;

FIG. 4 is a diagram illustrating time-related changes in the speeds of left and right wheels observed when a braking operation is performed on the μ-split road; and

FIGS. 5A, 5B and 5C are diagrams respectively illustrating time-related changes in a yaw rate, the operation angle of a steering wheel and the steering angle of steerable vehicle wheels observed when the braking operation is performed on the μ-split road.

### DESCRIPTION OF THE PREFERRED EMBODIMENTS

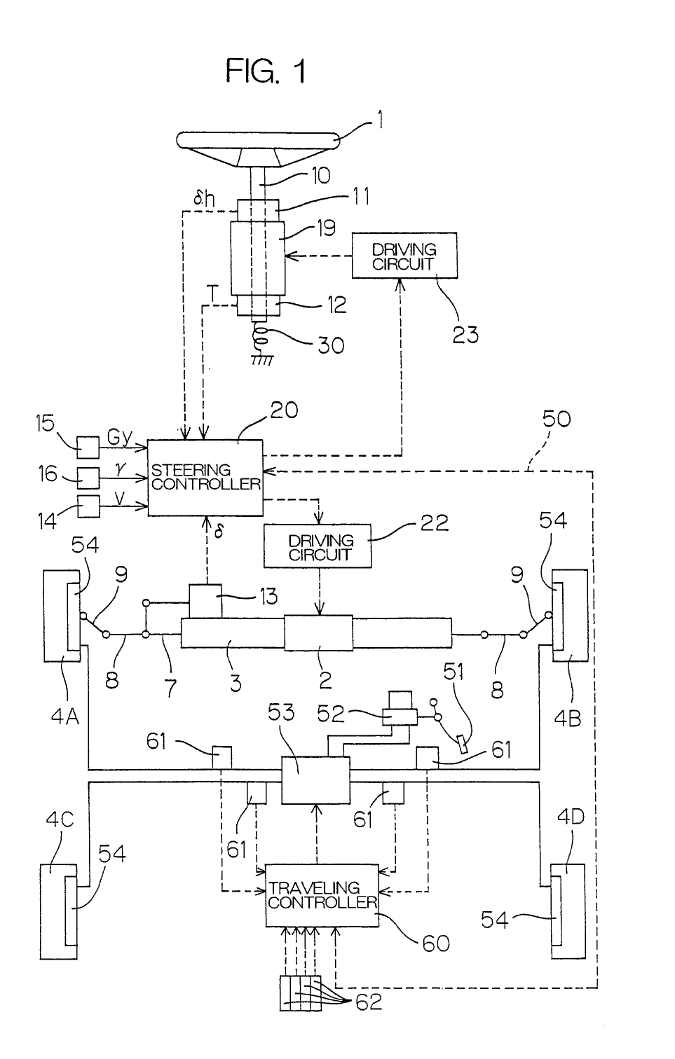

FIG. 1 is a conceptual diagram for explaining the basic construction of a steering system for a motor vehicle in accordance with one embodiment of the present invention. The motor vehicle steering system converts the motion of a steering actuator 2 driven in accordance with the turning operation of a steering wheel (steering operation member) 1 into the turning motion of left and right front wheels (steerable vehicle wheels) 4A, 4B via a steering gear 3. Thus, a steering operation is achieved with no mechanical coupling between the steering wheel 1 and the steering gear 3. In this case, the steering actuator 2, the steering gear 3 and the like constitute a steering mechanism.

The steering actuator 2 may be constituted, for example, by an electric motor such as a known brushless motor. The steering gear 3 has a motion converting mechanism (ball thread mechanism or the like) for converting the rotational motion of an output shaft of the steering actuator 2 into the linear axial motion of a steering rod 7 (traverse to the motor vehicle). The motion of the steering rod 7 is transmitted to knuckle arms 9 via tie rods 8 to turn the knuckle arms 9. Thus, the wheels 4A, 4B supported by the knuckle arms 9 are turned.

The steering wheel 1 is coupled to a rotation shaft 10 rotatably supported with respect to the motor vehicle. The rotation shaft 10 is provided with a counter force actuator 19 for applying a counter steering force to the steering wheel 1. More specifically, the counter force actuator 19 may be constituted by an electric motor such as a brushless motor having an output shaft provided integrally with the rotation shaft 10.

A resilient member 30 such as a coil spring is provided between the motor vehicle and an end of the rotation shaft 10 opposite from the steering wheel 1 for connection therebetween. The resilient member 30 returns the steering wheel 1 to a straight traveling steering position by its resilient force when the counter force actuator 19 applies no torque to the steering wheel 1.

For detection of an operation input value indicative of the degree of the operation of the steering wheel 1, the rotation shaft 10 is provided with an angle sensor 11 for detecting an operation angle δh corresponding to the rotation angle of the rotation shaft 10. The rotation shaft 10 is further provided with a torque sensor 12 for detecting an operation torque T applied to the steering wheel 1.

A steering angle sensor 13 for detecting a steering angle δ of the wheels 4A, 4B is provided as an output value sensor for detecting an output value of the steering actuator 2. The steering angle sensor 13 may be constituted by a potentiometer which detects the amount of the movement of the steering rod 7 moved by the steering actuator 2.

The angle sensor 11, the torque sensor 12 and the steering angle sensor 13 are connected to a steering controller 20 (steering control circuit) including a computer (ECU: electronic control unit).

The steering controller 20 controls the steering actuator 2 and the counter force actuator 19 via driving circuits 22 and 23, respectively. The steering controller 20 is further connected to a lateral acceleration sensor 15 for detecting a lateral acceleration Gy of the motor vehicle, a yaw rate sensor 16 for detecting a yaw rate γ of the motor vehicle, and a speed sensor 14 for detecting the speed V of the motor vehicle.

The steering controller 20 communicates with a traveling controller 60 (braking control circuit) for controlling the braking of the motor vehicle via a line 50 for data transmission. Data indicative of the lateral acceleration Gy, the yaw rate γ and the vehicle speed V respectively detected by the lateral acceleration sensor 15, the yaw rate sensor 16 and the speed sensor 14 are utilized in the steering controller 20, and transmitted to the traveling controller 60 via the line 50.

A braking pressure is generated by a master cylinder 52 in accordance with a stepping force applied onto a braking pedal 51. The braking pressure is amplified and distributed to braking devices 54 of the front wheels 4A, 4B and rear wheels 4C, 4D by a braking pressure control unit 53, whereby the respective braking devices 54 apply braking forces to the wheels 4A to 4D. Then, the braking pressure control unit 53 is controlled by the traveling controller 60 constituted by a computer (ECU) to independently control braking pressures to be applied on the respective wheels 4A to 4D.

The traveling controller 60 is connected not only to the steering controller 20 but also to braking force sensors 61 for independently detecting the braking forces applied to the respective wheels 4A to 4D and to wheel speed sensors 62 for independently detecting the rotation speeds of the respective wheels 4A to 4D.

The traveling controller 60 controls the braking pressure control unit 53 for the amplification and distribution of the braking pressure on the basis of the rotation speeds of the respective wheels 4A to 4D detected by the wheel speed sensors 62 and feedback values applied from the braking force sensors 61. Thus, the braking forces to be applied to the respective wheels 4A to 4D are independently controlled. The braking pressure control unit 53 is constructed so that the braking pressure can be generated by a built-in pump even if the brake pedal 51 is not operated.

The steering controller 20 and the traveling controller 60 respectively perform attitude control operations for stabilization of the behavior of the motor vehicle. That is, the steering controller 20 controls the steering actuator 2 for the stabilization of the behavior of the motor vehicle. More specifically, a target yaw rate γ* is calculated on the basis of the operation angle δh of the steering wheel 1, and the direction of the front wheels 4A, 4B is controlled so as to converge the actual yaw rate γ of the motor vehicle detected by the yaw rate sensor 16 at the target yaw rate γ* (yaw rate control).

On the other hand, the traveling controller 60 controls the braking pressures on the wheels located on an inner or outer side of the turning radius of the motor vehicle so as to converge the actual yaw rate γ of the motor vehicle at the target yaw rate γ* for the attitude control of the motor vehicle.

The steering controller 20 calculates the target yaw rate γ* on the basis of the operation angle δh and operation torque T of the steering wheel 1 during ordinary traveling. Further, a deviation of the actual yaw rate γ detected by the yaw rate sensor 16 from the target yaw rate γ* is calculated, and a target steering angle δ* which is a target value of the steering angle of the left and right front wheels 4A, 4B is calculated on the basis of the deviation. The steering actuator 2 is driven on the basis of a deviation of the actual steering angle δ detected by the steering angle sensor 13 from the target steering angle δ*. Thus, the steering operation is performed in accordance with the operation of the steering wheel 1.

Where the steering actuator 2 is constantly controlled on the basis of the deviation of the yaw rate, the motor vehicle tends to be heavily yawed during ordinary straight traveling, particularly during low speed traveling. That is, the steering actuator 2 is overcontrolled. For prevention of the overcontrol, control conditions as represented by the following expression (1) are preset. More specifically, the attitude control based on the deviation of the yaw rate is performed if the following control conditions are satisfied.

β/C1+β′/C2>1 and β β′>0 (1)

wherein β is the skid angle of the motor vehicle, β′ is the skid angular speed of the motor vehicle (β′=d β/dt), and C1 and C2 are constants (e.g., C1=1 degree and C2=5 degrees/sec).

Thus, the steering control for the attitude control is performed only when the skid angle β diverges, so that the yaw of the motor vehicle can be prevented.

In the prior art, the aforesaid control is employed even during the braking operation, thereby failing to stabilize the attitude of the motor vehicle during the braking operation, particularly on the μ-split road. That is, where the aforesaid control conditions are employed for the attitude control through the control of the steering mechanism, the control operation is performed with a time lag. The time lag of the control makes it impossible to suppress the yaw rate occurring on the motor vehicle at the initial stage of the braking operation on the μ-split road, making the attitude of the motor vehicle unstable. Therefore, the driver has to properly perform the steering operation for the stabilization of the attitude of the motor vehicle.

To solve this problem, the steering controller 20 controls the steering mechanism on the basis of braking condition data applied from the traveling controller 60 in response to detection of the braking operation on the μ-split road in this embodiment.

That is, the steering controller 20 acquires the braking condition data from the traveling controller 60 via the communication line 50. The braking condition data includes stop lamp signal data STP, speed comparison data WHv indicative of which of the left and right front wheels 4A and 4D has a higher wheel speed, and judgment result data Wth indicative of whether or not a speed difference between the left and right front wheels 4A and 4B exceeds a predetermined threshold value (e.g., 1.5 to 2.0 km/h).

The traveling controller 60 calculates the speed difference between the left and right front wheels 4A and 4B on the basis of the wheel speed data of the four wheels 4A to 4D inputted from the wheel speed sensors 62. Then, the traveling controller 60 compares the speed difference thus calculated with the predetermined threshold value, and outputs the result of the comparison as the judgment result data Wth via the communication line 50. The traveling controller 60 prepares the speed comparison data WHv indicative of which of the left and right front wheels 4A and 4B has a higher wheel speed, and outputs the speed comparison data WHv via the communication line 50. The stop lamp signal data STP is data indicative of whether or not stop lamps of the motor vehicle are lit, and corresponds to braking mechanism status data indicative of whether or not the braking mechanism is active.

The stop lamp signal data STP, the speed comparison data WHv and the judgment result data Wth are each represented on a one-bit basis. Data transmission between the steering controller 20 and the traveling controller 60 is carried out on a one-byte (8 bits) basis. Therefore, the aforesaid braking condition data utilizes 3 bits in one-byte data to be transmitted via the communication line 50.

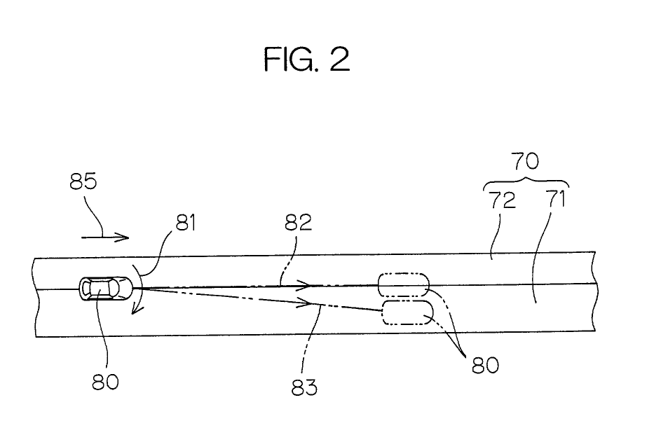

FIG. 2 is a schematic diagram for explaining how the braking operation is performed on a so-called μ-split road. The μ-split road 70 has a high μ road surface 71 such as a dry asphalt road surface and a low μ road surface 72 such as an iced road surface, which are respectively located on the right side and the left side of the motor vehicle 80 with respect to a traveling direction 85.

When the braking pedal 51 is stepped down with the right wheels 4B, 4D of the motor vehicle 80 being on the high μ road surface 71 and with the left wheels 4A, 4C being on the low μ road surface 72, a yaw moment acts on the motor vehicle 80 in an arrow direction 81. The steering controller 20 and the traveling controller 60 respectively perform the attitude control operations so as to counter-balance the yaw moment acting in the arrow direction 81.

Where the conventional steering attitude control is carried out during the braking operation with the steering wheel 1 maintained as close as consciously possible to a neutral position, the motor vehicle 80 travels along a curved line 83 due to a delay in the control. For prevention of such a behavior of the motor vehicle, the driver busily operates the steering wheel 1 to direct the motor vehicle 80 in the traveling direction 85 in an attempt to cause the motor vehicle 80 to travel along a substantially straight line indicated by a reference character 82.

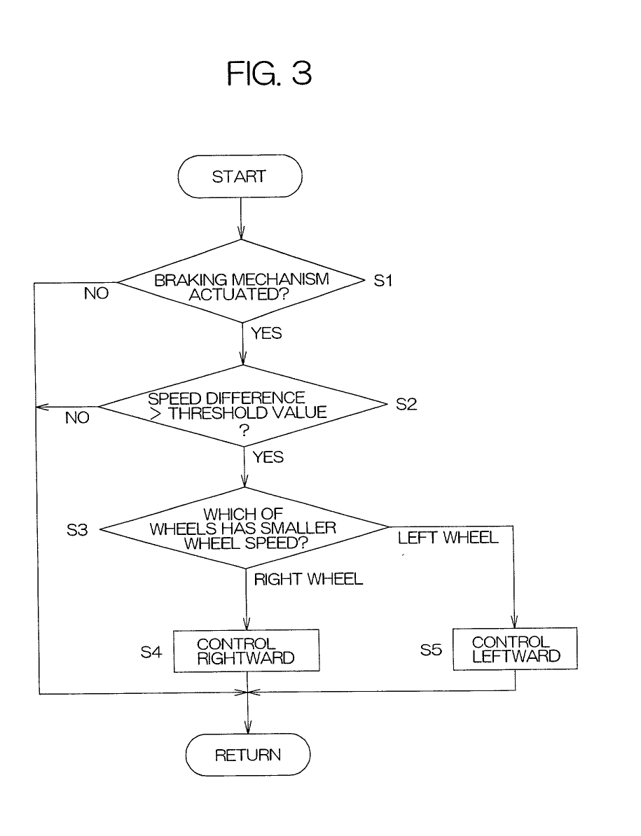

FIG. 3 is a flow chart for explaining the operation of the steering controller 20. The steering controller 20 judges, with reference to the stop lamp signal data STP, whether or not the braking mechanism is active (Step S1). If the braking mechanism is active, the steering controller 20 further judges, with reference to the judgment result data Wth, whether or not the speed difference between the left and right front wheels 4A and 4B exceeds the threshold value (Step S2). If this judgment is positive, the steering controller 20 further judges, with reference to the speed comparison data WHv, which of the left and right front wheels 4A, 4B has a lower wheel speed (Step S3). If the wheel speed of the right front wheel 4B is lower, the steering controller 20 adds a control steering angle to the target steering angle δ* for turning the front wheels rightward by a predetermined steering angle (e.g., about 2 degrees) (Step S4). If the wheel speed of the left front wheel 4A is lower, on the other hand, the steering controller 20 adds a control steering angle to the target steering angle δ* for turning the front wheels leftward by a predetermined steering angle (e.g., about 2 degrees) (Step S5). Thus, a control yaw moment for turning the front wheels toward the lower-speed wheel is applied to the motor vehicle.

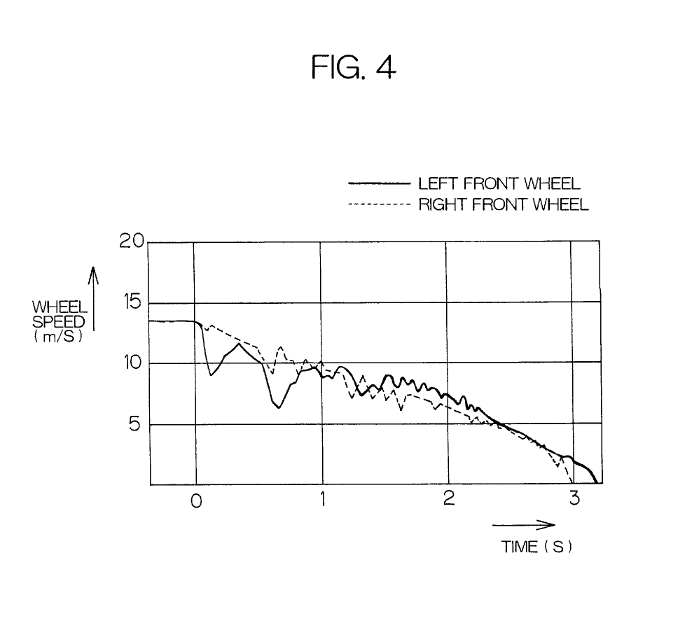

FIG. 4 is a diagram illustrating time-related changes in the wheel speeds observed when the braking operation is performed on the μ-split road. FIG. 4 shows the time-related changes in the wheel speeds after the start of the braking of the left and right front wheels 4A, 4B. The wheel speed of the right front wheel 4B on the high μ road surface 71 is not abruptly reduced even immediately after the application of the braking pressure. On the other hand, the left front wheel 4A on the low μ road surface 72 is more liable to skid and, therefore, the wheel speed thereof is abruptly reduced upon the application of the braking pressure. At this time, the yaw moment occurs in the arrow direction 81 as shown in FIG. 2.

The steering controller 20 adds the control steering angle to the target steering angle δ* so as to apply the control yaw moment to the motor vehicle 80 toward the lower-speed wheel, i.e., leftward. Thus, the attitude of the motor vehicle is stabilized by a so-called counter steering control operation as well as the operation of the steering wheel 1. Therefore, the driver does not have to busily operate the steering wheel 1 to drive the motor vehicle 80 along the straight line 82 (see FIG. 2) and stop the motor vehicle 80 with the attitude of the motor vehicle kept stable.

The aforesaid attitude control based on the braking condition data applied from the traveling controller 60 is promptly carried out whether or not the control conditions represented by the expression (1) are satisfied. In this embodiment, the ECU (electric control unit) constituting the steering controller 20 repeatedly performs the computations for the control of the steering actuator 2 in a control cycle of 10 msec.

If it is judged on the basis of the stop lamp signal data STP that the braking mechanism is actuated, the steering controller 20 adds the predetermined control steering angle to the target steering angle δ* for turning the left and right front wheels toward the lower-speed wheel on condition that the judgment result data Wth has a value indicating that the speed difference between the left and right front wheels 4A and 4B exceeds the threshold value, for example, after 4 or 5 control cycles. By adding the control steering angle to the target steering angle δ* with a lag of a predetermined very short period (40 to 50 msec) after the actuation of the braking mechanism, the ordinary braking operation is prevented from being improperly performed, and the overcontrol is prevented even during the braking operation. In addition, the motor vehicle 80 suffers from no significant front turn in a very short period on the order of 4 to 5 control cycles. Therefore, the yaw moment acting on the motor vehicle 80 can be suppressed with a satisfactory responsiveness in accordance with this embodiment.

The time lag of the steering control based on the braking condition data is equal to the predetermined very short period (40 to 50 msec), which is much shorter than the time lag of the conventional steering control (120 to 130 msec). Thus, the attitude control through the control of the steering mechanism at the braking can be performed with a much improved responsiveness.

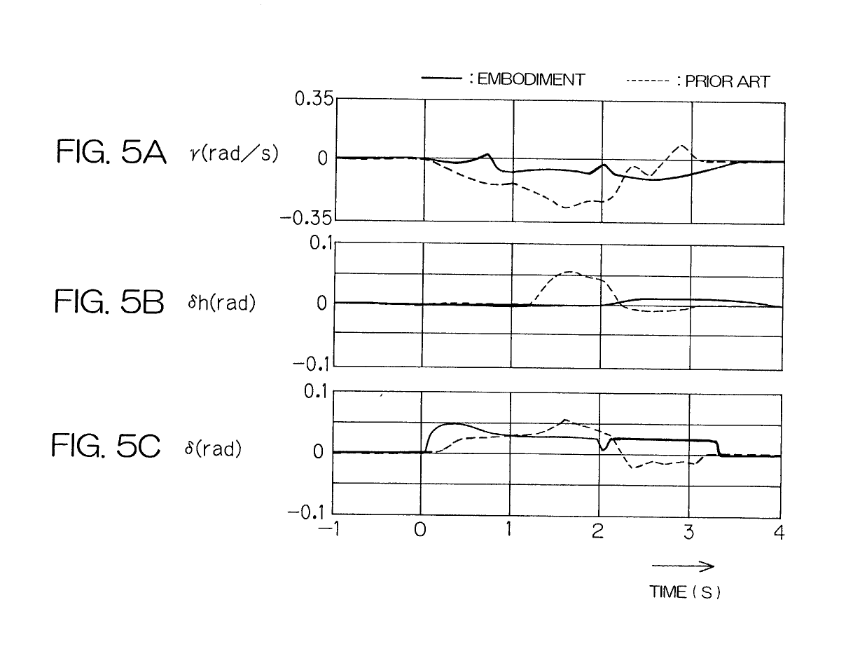

FIGS. 5A, 5B and 5C are graphs showing the results of an experiment conducted by the inventors of the present invention. FIG. 5A illustrates a time-related change in the yaw rate γ of the motor vehicle 80, and FIG. 5B illustrates a time-related change in the operation angle δh of the steering wheel 1. FIG. 5C illustrates a time-related change in the steering angle δ detected by the steering angle sensor 13. In FIGS. 5A to 5C, the results of an experiment conducted in accordance with the prior art are also shown.

As can be understood from FIG. 5A, the yaw rate γ of the motor vehicle 80 is remarkably stabilized by employing the control according to this embodiment. As can be understood from FIG. 5B, the steering wheel 1 is less frequently operated for keeping the motor vehicle 80 traveling straight. This means that, even if the braking operation is abruptly performed on the μ-split road, the attitude of the motor vehicle 80 can be stabilized irrespective of the skill of the driver. As can be understood from FIG. 5C, the steering angle changes with a remarkably improved responsiveness at the initial stage of the braking operation.

In accordance with this embodiment, it is considered that the braking operation is performed on the μ-split road, if the speed difference between the left and right front wheels 4A and 4B exceeds the predetermined threshold value when the braking mechanism is active. When the braking operation is performed on the μ-split road, the yaw moment acting on the motor vehicle 80 at the initial stage of the braking operation is suppressed with a satisfactory responsiveness by the addition of the predetermined control steering angle for turning the front wheels toward the lower-speed wheel. Thus, the braking operation can properly be performed with the attitude of the motor vehicle 80 kept stable even if the braking operation is abruptly performed on the μ-split road.

While the embodiment of the present invention has thus been described, the invention may be embodied in any other ways. In the embodiment described above, the predetermined control steering angle is added to the target steering angle δ* for turning the front wheels toward the lower-speed wheel when the attitude control is performed on the basis of the braking condition data. However, the control steering angle to be added to the target steering angle δ* for the attitude control based on the braking condition data is not necessarily required to be constant. For example, the control steering angle may variably be set depending on the speed difference between the left and right front wheels 4A and 4B. Alternatively, the control steering angle may variably be set depending on a difference between braking forces or braking pressures applied to the left and right front wheels 4A and 4B. Otherwise, the control steering angle may variably be set depending on a physical quantity, as long as the physical quantity properly changes with the difference between the braking forces applied to the left and right front wheels 4A and 4B.

In the aforesaid embodiment, the stop lamp signal data STP, the speed comparison data WHv and the judgment result data Wth are applied to the steering controller 20 from the traveling controller 60 via the communication line 50. However, the stop lamp signal data STP and data indicative of the speeds of the left and right front wheels 4A, 4B may be applied to the steering controller 20 from the traveling controller 60 via the communication line 50. In this case, the steering controller 20 compares the speeds of the left and right front wheels 4A and 4B with each other, and judges whether or not the speed difference between the wheels 4A and 4B exceeds the predetermined threshold value.

In the aforesaid embodiment, an explanation has been given to the case where the attitude control is achieved through the control of the steering mechanism as well as through the control of the braking mechanism. However, the traveling controller 60 is not necessarily required to perform the attitude control through the control of the braking mechanism. That is, the present invention is applicable to a case where the attitude control of the motor vehicle 80 is performed only through the control of the steering mechanism. Of course, the data related to the wheel speeds is not necessarily required to be obtained from the traveling controller 60 via the communication line 50, but output signals of the wheel speed sensors 62 may directly be inputted to the steering controller 20.

Although the aforesaid embodiment is directed to a so-called steer-by-wire system which has no mechanical connection between the steering mechanism and the steering wheel 1, the present invention is applicable to a motor vehicle steering system in which a steering wheel 1 is mechanically coupled to a steering mechanism. For example, the attitude control of the motor vehicle can be achieved by controlling the steering angle of steerable wheels with the use of a power steering system adapted to apply a steering assist force to a steering mechanism. Further, the present invention is applicable to such an arrangement that a clutch is interposed between the steering wheel 1 and the steering mechanism to allow for mechanical coupling and decoupling therebetween as required.

While the present invention has been described in detail by way of the embodiment thereof, it should be understood that the foregoing disclosure is merely illustrative of the technical principles of the present invention but not limitative of the same. The spirit and scope of the present invention are to be limited only by the appended claims.

This application corresponds to Japanese Patent Application No. 2000-158589 filed to the Japanese Patent Office on May 29, 2000, the disclosure thereof being incorporated herein by reference.

What is claimed is:

1. A motor vehicle steering system for controlling driving of a steering mechanism of a motor vehicle, the motor vehicle steering system comprising:
brake actuation detecting circuit for detecting actuation of a braking mechanism of the motor vehicle;
speed comparing circuit for judging which of left and right wheels of the motor vehicle has a higher wheel speed;
speed judging circuit for judging whether a speed difference between the left and right wheels of the motor vehicle exceeds a predetermined threshold value; and
steering control circuit for controlling the steering mechanism on the basis of a result of the judgment by the speed comparing circuit in response to the detection of the actuation of the braking mechanism by the brake actuation detecting circuit so as to additionally turn steerable wheels of the motor vehicle by a control steering angle toward one of the left and right wheels having a lower wheel speed on condition that the speed judging circuit judges that the speed difference between the left and right wheels exceeds the threshold value.

2. A motor vehicle steering system as set forth in claim 1, wherein the steering control circuit controls the steering mechanism so as to additionally turn the steerable wheels by the control steering angle toward the lower-speed wheel on condition that the speed difference exceeds the threshold value after a lapse of a predetermined period from the detection of the actuation of the braking mechanism.

3. A motor vehicle steering system as set forth in claim 1, wherein the control steering angle has a constant value.

4. A motor vehicle steering system as set forth in claim 1, wherein the control steering angle is variably set depending on a difference in braking condition between the left and right wheels.

5. A motor vehicle steering system as set forth in claim 1, which cooperates with braking control circuit for controlling the braking mechanism of the motor vehicle.

6. A motor vehicle steering system as set forth in claim 5, wherein the braking control circuit applies to the steering control circuit, via a communication line, a signal indicative of whether or not the braking mechanism of the motor vehicle is active.

7. A motor vehicle steering system as set forth in claim 5, wherein the braking control circuit applies to the steering control circuit, via a communication line, a signal indicative of information related to wheel speeds of the left and right wheels of the motor vehicle.

8. A motor vehicle steering system as set forth in claim 7, wherein the information related to the wheel speeds of the left and right wheels of the motor vehicle includes data indicative of which of the left and right wheels of the motor vehicle has a higher wheel speed.

9. A motor vehicle steering system as set forth in claim 7, wherein the information related to the wheel speeds of the left and right wheels of the motor vehicle includes data indicative of whether or not the speed difference between the left and right wheels of the motor vehicle exceeds the threshold value.

10. A motor vehicle steering system as set forth in claim 1, wherein the steering mechanism has no mechanical connection to a steering operation member, or is adapted to be brought out of mechanical engagement with the steering operation member.
